(19) United States
(12) Patent Application Publication
(10) Pub. No.: US 2015/0280930 A1
(43) Pub. Date: Oct. 1, 2015

(54) SYSTEMS AND METHODS FOR IMPLEMENTING REAL-TIME EVENT NOTIFICATIONS

(71) Applicant: EBAY INC., San Jose, CA (US)

(72) Inventors: Kamal Zamer, Austin, TX (US); Lucy Ma Zhao, Austin, TX (US); Jayasree Mekala, Austin, TX (US)

(21) Appl. No.: 14/226,399

(22) Filed: Mar. 26, 2014

(51) Int. Cl. H04L 12/18; H04L 29/08; H04B 5/00

(52) U.S. Cl. CPC H04L 12/189; H04B 5/0031; H04L 67/306

(57) ABSTRACT

A system or method is provided to implement event notifications in real time. In particular, a possible event occurrence, such as a spontaneous or unannounced musical concert, is detected based on a user's interactions with the user's communication device, such as the user's video or audio recording of an event or communication regarding an event, such as texting, tweeting, online posting, social network comments, and etc. An event notification may be generated based on the possible occurrence of this event. The user's communication device may broadcast this event notification via Bluetooth or Near-Field Communication (NFC) to other nearby communication devices. As such, users of the nearby communication devices may be notified of the occurrence of the event. In another embodiment, a communication device may receive various event notifications broadcasted from nearby communication devices. Relevant notifications may be selected and presented to the user based on a user's preferences.

### BACKGROUND

The present invention generally relates to systems and methods for implementing real-time event notifications.

With modern technology, consumers have access to information regarding various events via the internet. For example, event information for entertainment or sporting events are searchable via online event portals or search engines. Nevertheless, information for some events, such as spontaneous or last-minute concerts, remains unsearchable online. As such, a consumer may not be notified and may miss these unannounced spontaneous concerts even if these concerts are held near the consumer and the consumer is interested in attending these unannounced events. Accordingly, there is a need for a system or method that implements real-time event notifications for these unannounced events.

### BRIEF DESCRIPTION OF THE FIGURES

FIG. 1 is a block diagram of a networked system suitable for implementing real-time event notifications according to an embodiment.

FIG. 2 is a flowchart showing a process of generating and broadcasting event notifications according to one embodiment.

FIG. 3 is a flowchart showing a process for receiving event notifications according to one embodiment.

FIG. 4 is a block diagram of a computer system suitable for implementing one or more components in FIG. 1 according to one embodiment.

FIG. 5 is a diagram depicting communication devices within a Bluetooth beacon broadcast range according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system or method is provided to implement event notifications in real time. In particular, an event occurrence, such as a spontaneous or unannounced musical concert or public presentation, is detected or determined based on a user's interactions with the user's communication device, such the user's video or audio recording of an event or communication regarding an event, such as texting, tweets, online postings, social network comments, and etc. An event notification may be generated based on the occurrence of this event. The user's communication device may broadcast this event notification via Bluetooth or Near-Field Communication (NFC) to other nearby communication devices. As used herein, NFC may include Bluetooth, Low Energy communication, as well as other forms of NFC communication. As such, users of the nearby communication devices may be notified of the occurrence of the event.

In an embodiment, a communication device may receive various event notifications broadcast from other nearby communication devices. The communication device may determine or select relevant notifications from the received notifications based on a user's preferences. For example, when a concert notification is received, the communication device may determine whether the user is interested in the concert based on the user's music preference. The user's preference may be collected or determined based on the user's purchase history, browsing history, communication history, or user's input. Further, each event notification may include a time stamp indicating when the event notification was generated. The communication device may re-broadcast the event notifications that were recently generated based on their time stamps.

The system or method may allow news or notifications of spontaneous or unannounced events to be broadcast by crowd sourcing. In particular, the news or notifications may be broadcast by mobile communication devices via NFC or Bluetooth Low Energy (BLE) communication, such that the news or notifications may spread from the users, who are experiencing or who have experienced the event, to other nearby users gradually in a bleeding out or rippling effect.

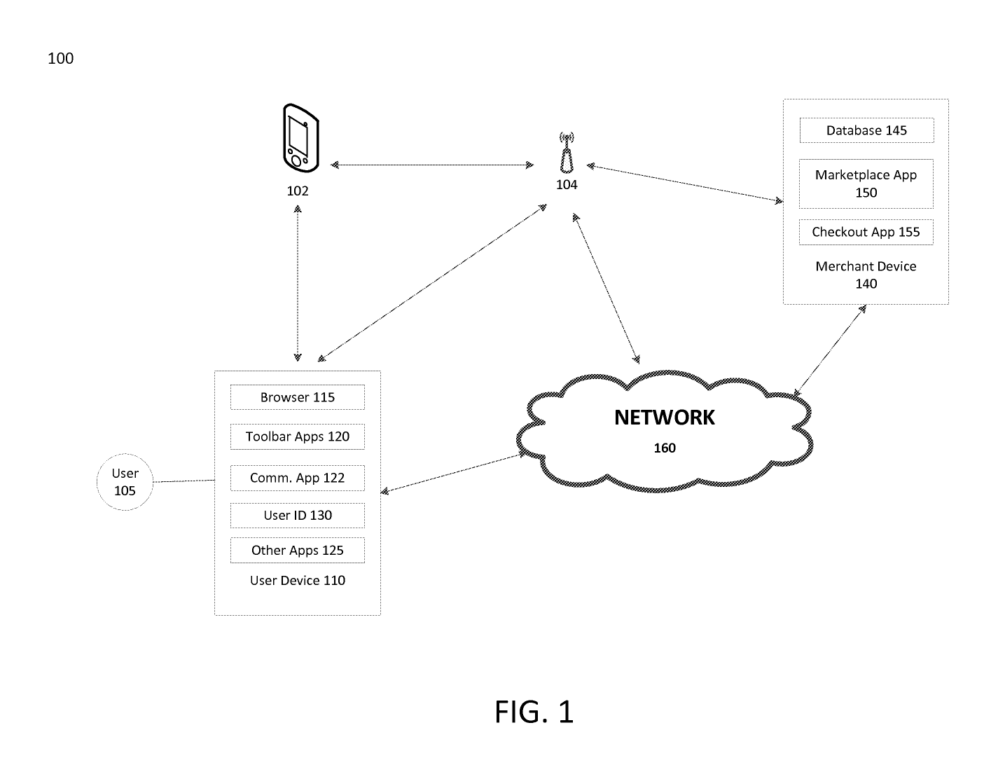

FIG. 1 is a block diagram of a networked system 100 suitable for implementing a process for implementing event notifications according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a communication device 102, a Bluetooth beacon 104, and a merchant server 140 in communication over a network 160. Merchant server 140 may be maintained by a ticket exchange service provider, such as StubHub, Inc. of San Francisco, Calif. A user 105, such as a sender or consumer, may utilize user device 110 to search and purchase event tickets using merchant server 140. A user 105 may utilize user device 110 to browser, find, and pay for a ticket using merchant server 140. For example, a ticket purchase application provided by the ticket exchange service provider may be installed at user device 110 to facilitate ticket purchase by connecting user device 110 to merchant device 110 via network 160.

User device 110 may include a Bluetooth device configured to implement low energy Bluetooth communication. Bluetooth beacon 104 may be a or part of a system including a network of low energy Bluetooth beacons installed at various locations inside a public event, such as, a fair ground, a concert hall, or a stadium. Thus, the Bluetooth beacons 104 may facilitate the detection of the location and movements of user device 110 or communication device 102 in the public event. The Bluetooth beacons 104 also may facilitate event notifications among communication devices, such as user device 110 and communication device 102.

User device 110, communication device 102, Bluetooth beacons 104, and merchant server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, laptop computer, a computing tablet, a wearable computing device, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications. In addition, user device 110 may include a microphone and an application for making audio recordings. User device 110 also may include a camera and an application for taking pictures or video recordings. Thus, user device 110 may take pictures or make audio/video recordings of an event in real time.

Applications 125 may also include email, texting, voice and IM applications that allow user 105 to send and receive emails, calls, and texts through network 160. User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a ticket exchange service provider to associate user 105 with a particular account maintained by the ticket exchange service provider. A communications application 122, with associated interfaces, enables user device 110 to communicate within system 100.

User device 110 may include a Bluetooth device configured to implement low energy Bluetooth (BLE) communication. For example, user device 110 may detect various low energy Bluetooth signals from Bluetooth beacons installed in public event. Thus, locations and movements of user device 110 may be determined by positioning techniques, such as triangulation or location fingerprinting, based on the received BLE signals. User device 110 also may send and receive information or notifications via BLE. For example, user device 110 may send and receive event notifications from other nearby communication devices or from a nearby Bluetooth beacon.

User derive 110 also may collect location data using Global Positioning System (GPS) to identify a location of user device 110. Other means for collecting location data, such as WiFi devices, Near-Field Communication (NFC) devices, or the like also may be included in user device 110 for determining a location of user device 110. Thus, user device 110 may determine a current location of user device 110 based on the collected location data. In another embodiment, user device 110 may send the location data to merchant server 140 and merchant server 140 may determine a current location of user device 110 based on the location data. These positioning techniques may be used in combination with BLE communication to provide dynamic positioning of user's location.

Communication device 102 may be operated by another user. Communication device 102 may have one or more similar components as that of user device. In particular, communication device 102 may include similar components for communication via BLE or NFC.

Merchant server 140 may be maintained, for example, by a ticket exchange service provider offering various event tickets. The ticket exchange service provider may have a physical point-of-sale (POS) store front and/or an online store. The ticket exchange service provider merchant may provide a marketplace for facilitating buying and selling of various event tickets between buyers and sellers.

Merchant server 140 may include a database 145 identifying available event tickets, which may be made available for viewing and purchase by user 105. Accordingly, merchant server 140 also may include a marketplace application 150 which may be configured to serve information over network 160 to browser 115 of user device 110. In one embodiment, user 105 may interact with marketplace application 150 through browser 115 or ticket purchase application over network 160 in order to view various event tickets identified in database 145.

Merchant server 140 also may include a checkout application 155 which may be configured to facilitate the purchase by user 105 of event tickets. Checkout application 155 may be configured to accept payment information from or on behalf of user 105 through a payment service provider over network 160. For example, checkout application 155 may receive and process a payment confirmation from the payment service provider, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Merchant server 140 may maintain account information of various users. For example, users may register with the ticket exchange service provider at merchant server 140 to establish an account for selling or purchasing tickets. The user account may include the user's payment information, purchase history, browsing history, event preferences, music preferences, entertainment/sports preferences, and other information about the user. Merchant server 140 may generate event recommendations or promotions based on the user's various preferences.

Merchant server 140 may be connected to a network of Bluetooth beacons 104 installed in a public event location, such as a concert hall or a stadium. The network of Bluetooth beacons 104 may be installed at respective locations throughout the public event to form a grid. Each Bluetooth beacon may emit a low energy Bluetooth signal in specific frequency spectrum periodically. Thus, the network of Bluetooth beacons 104 may allow detection of locations and movements of customers in the public event. Bluetooth beacons 104 also may serve as information exchange portals for communication devices connected to the Bluetooth beacons. For example, Bluetooth beacons 104 may facilitate the exchange of event notifications among various communication devices. In an embodiment, the network of Bluetooth beacons may be connected to merchant server 140 remotely via network 160. In another embodiment, other wireless beacons, such as WiFi or NFC beacons, may be used in place of one or more Bluetooth beacons 104 to facilitate event notification exchange among communication devices.

Merchant server 140 may maintain a database including the location of each Bluetooth beacons in the public event. Thus, based on the location of the detected Bluetooth beacons, the location of a user may be determined by triangulation or location fingerprinting. Further, the database may include a layout of the public event, such as the locations of various venues in the public event and overall maps of stadiums or concert halls. The respective locations of the network of Bluetooth beacons may be included in the map or layout of the public event. Thus, merchant server 140 may determine various locations, such as venue location or amenity location in the public event with respect to the network of Bluetooth beacons.

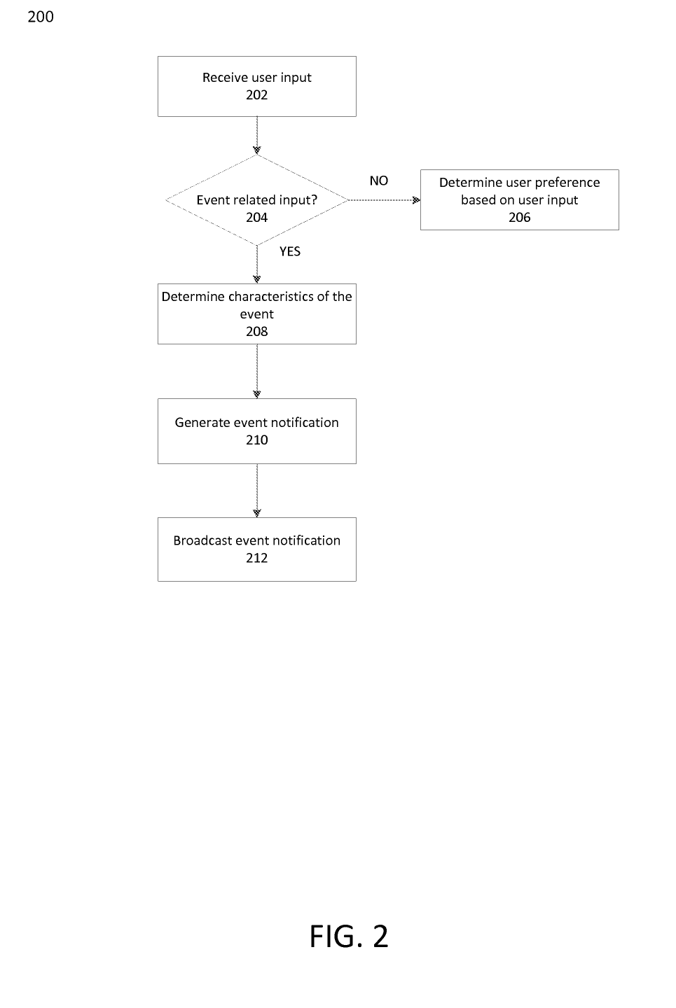

FIG. 2 is a flowchart showing a process 200 of generating and broadcasting event notifications according to one embodiment. At step 202, user device 110 may receive user input at user device 110. In one embodiment, user device 110 may forward the user input to merchant server 140. The user input may include various interactions between user 105 and user device 110. In particular, the user input may include browsing activities on the internet or the website of the ticket exchange service provider, purchase activities, payment activities, audio/video recordings, user communication, such as texting, online posting, tweeting, etc.

At step 204, user device 110 or merchant server 140 may determine whether the user input is related to an event. The event may include concerts, sport/entertainment events, presentations, shows, incidents, sightings, parties, gatherings, or the like. In particular, user device 110 or merchant server 140 may analyze the content of the input to determine whether the input is event related. For example, if the input includes text, user device 110 or merchant server 140 may identify any keywords or terms that are related to an event. Keywords or terms that are related to an event may include terms such as “show,” “concert,” “performance,” “gig,” “live,” “presentation,” “production,” “musical,” or other event related terms. Other terms, such as names of well-known artists or celebrities or well-known events, such as SXSW (South by Southwest), also may be identified from the input. If the input is an audio or a video recording or a picture, image recognition techniques and/or audio recognition techniques may be used to recognize songs or artists. If a potential event related input is determined, user device 110 or merchant server 140 may inquire user 105 whether the input is related to a live or real-time event or whether user 105 is attending a live event. Thus, user 105 may indicate or confirm whether the input is related to an occurrence of a real-time event.

If the input is not event related, user device 110 or merchant server 140 may analyze the input to determine user preferences at step 206. For example, user input may include purchase activities, browsing activities, communication activities, video viewing or audio listening activities, and user movements/locations. These user inputs may be used to determine the user's preference in music, movies, shopping, trend, location, and etc. For example, from the user's music streaming or purchase activities, a music category, genre, artist, and/or style may be determined for the user. In another example, based on the user's ticket purchase history, the user's preference for sports teams or artists may be determined. The user preferences may be stored as a user profile associated with the user's account at the ticket exchange service provider.

If the input is event related, user device 110 or merchant server 140 may determine the various characteristics of the event at step 208. In an embodiment, user 105 may be requested to provide various information of the event. For example, the system may ask user 105 whether the event is a live event, the type of event, the time and/or the duration of the event, the performer or presenter, contents being presented or performed at the event, etc.

In some embodiments, the characteristics of the event may be extracted from the user input received at step 202. For example, based on the time and location of user input, the time and location of the event may be determined. Also, based on the content of the user input, such as text message, pictures, and/or video/audio recording, the content or the presenter/performer of the event may be determined. In particular, audio and/or video recognition techniques may be used to analyze and identify the presenter/artist or the contents being presented or performed at the event.

In an embodiment, the system may retrieve other information related to the event based on information extracted from the user input. For example, if the time and location of the event is identified based on the user input, other information related to the event, such as the name of the event, performer/presenter, contents, or other information of the event may be retrieved from an event database or obtained by performing a search. In particular, the ticket exchange service provider may already have an event database including information for various events. Thus, if the location and time of the event is known, information related to the artist/performer or content of the event may be obtained by referencing the event database. If the event is found in the event database, the merchant server 140 may determine whether tickets are required for admission and whether space or tickets are available for the event. If no event matching the event related input is found in the event database, the event may be labeled as an unannounced or spontaneous event.

At step 210, an event notification may be generated based on the event-related input. The notification may include information determined from step 208 which may include one or more of the name of the event, the time and location of the event, the duration of the event, the presenter/performer of the event, the content of the event, and other information related to the event. Further, directions for attending the event may be included to inform a customer how to attend the event. If the event requires admission tickets, the notification may include a link or a user interface for a customer to purchase a ticket for the event.

At step 212, the event notification may be broadcast from user device 110 to other nearby communication devices, such as communication device 102. The event notification may be broadcast via BLE or NFC communication to nearby communication devices. The event notification may be broadcast for a predetermined length of time based on the duration of the event. If the duration of the event is not known, the event notification may be broadcast for a default length of time. In an embodiment, the event notification may be time stamped to indicate when the event notification was generated. Thus, the event notification may be broadcast for a predetermined length of time after the time stamp. In some embodiment, user device 110 may continue to broadcast the event notification even when user 105 moves away from the event, such that other nearby or passing-by communication devices may be notified of the event.

In an embodiment, the beacon 104 or the network of beacons 104 may serve as an event notification exchange portal. In particular, the network of beacons 104 may be installed throughout a venue, such as a stadium or a concert hall, to receive various event notifications from various communication devices. A server, such as merchant server 140, may be connected to the network of beacons 104 to collect and organize these event notifications and then broadcast the event notifications to communication devices via the network of beacons 104. Thus, the network of beacons 104 may serve as notification exchange portals to streamline the exchange of event notifications within a venue. Power levels of the beacons may be adjusted to ensure adequate coverage within a venue or location.

By utilizing the above process 200, event related user input may be identified. Event notifications then may be generated for the identified event including characteristics of the event and broadcast from user device 110 to other nearby devices via BLE or NFC communication. Thus, unannounced or spontaneous events may be found or identified and event notifications for these unannounced or spontaneous events may be generated and broadcasted to nearby customers.

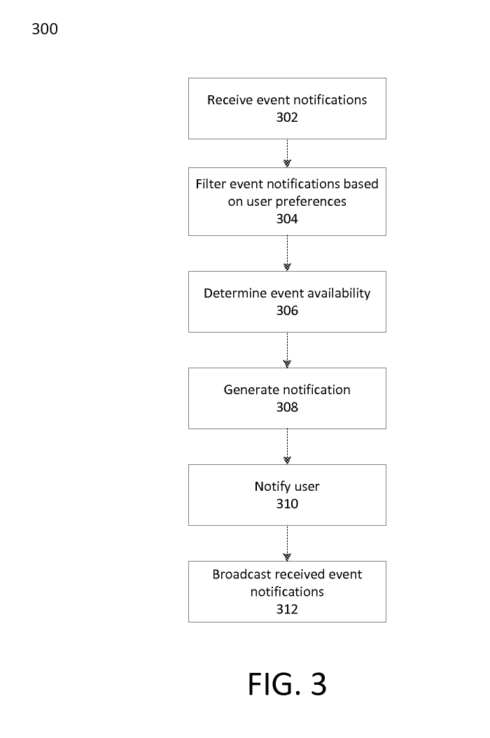

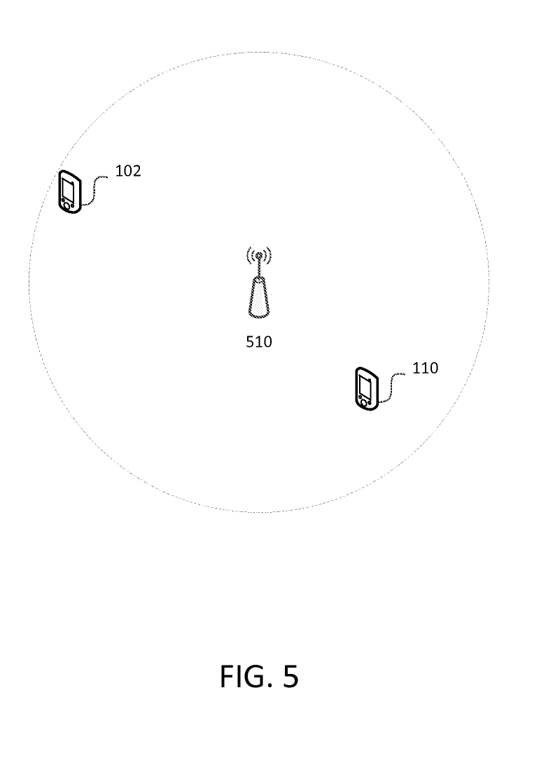

FIG. 3 is a flowchart showing a process for receiving event notifications according to one embodiment. At step 302, user device 110 may receive event notifications from various nearby communication devices via BLE or NFC communication. For example, as shown in FIG. 5, user device 110 may receive event notifications from communication device 102. In another embodiment, communication device 102 may broadcast event notifications to beacon 510. Beacon 510 may collect and aggregate event notifications from various communication devices such as communication device 102 and user device 110 and may broadcast the received event notifications to communication devices located within beacon 510's broadcast range (indicated as a circular dashed line).

At step 304, user device 110 may filter event notifications based on user's preferences. For example, user device 110 may receive a large number of event notifications from other nearby communication devices or from beacon 104. The large number of event notifications may be filtered to provide relevant notifications to user 105. Relevant event notifications may be selected based on user 105's preferences, such as by scanning music stored on or through the user device, purchase history of music tickets, purchase history of digital music, purchase history of CDs, etc. For example, musical concert notifications may be selected based on user's musical preference, such as genre, artist, category, location, similar musical style or quality, etc. Thus, event notifications for concerts that user 105 is interested in may be selected.

At step 306, user device 110 may determine the availability of the events. In particular, based on the characteristics of the event included in the event notification, the time and duration of the event may be extracted to determine whether the event still is occurring. Further, the location of the event may be used to determine whether user 105 would have sufficient time to travel from user 105's current location to the event location before the event ends. In addition, if the event requires admission tickets, user device 110 or merchant device 140 may check with ticket merchants or ticket exchange service to determine whether admission tickets are still available for purchase. In one embodiment, the event notification may include a link or an interface for user 105 to purchase a ticket for the event.

For events that have unknown duration, a probability of availability may be determined based on the length of time that has elapsed since the event was found or detected or since the event notification was generated. If the event was detected and the event notification was generated very recently, the probability that the event is still taking place may be greater. If the event was detected and the event notification was generated a while ago, the probability that the event is still taking place may be low. Thus, customers may determine whether the event is still available based on the probability. Availability may also be determined based on the type of event, e.g., a festival, a concert, a recital, a musical, etc.

At step 310, the event notifications may be presented to the user to notify the user. In an embodiment, all received event notifications may be presented to the user in a list. More relevant event notifications may be presented in the front of the list. In another embodiment, only relevant event notifications are presented to the user. Advertisements or promotions may be included with event notifications to entice the user to attend or purchase tickets to similar events. For example, if an event requires an admission ticket, a link may be provided with the event notification to direct the user to a ticket merchant's website to purchase an admission ticket for the event.

An interface also may be provided to receive the user's feedback regarding the event notifications. For example, the user may indicate whether an event notification is relevant or of interest to the user. A popular (hot) event may be determined when a greater number of users indicate that the event is of great interest. The user also may indicate whether the event notification is accurate. The user's feedback may be sent to merchant device 140 to provide confirmation or correction to the event notification.

At step 312, the event notifications received by user device 110 also may be broadcast by user device 110 to other nearby devices. In an embodiment, user device 110 may broadcast all received event notifications. In another embodiment, the event notifications that are relevant to user 105 or are accurate may be broadcast from user device 110. In an embodiment, the event notifications that are most recently created are broadcast. For example, each event notification may be time stamped with the created time/date. The event notification may be broadcast for a predetermined length of time after it is created. This may ensure that the newer or fresher events are sent to the customers. Thus, user device 110 may determine whether an event notification is recently created based on the time stamp, and if so, the event notification may continue to be broadcast. The length of broadcast time may be determined based on the duration or the type of event. For example, if the duration of the event is known, the broadcast time may be set based on the duration of the event. In another example, spontaneous events, such as a flash mob performance, may have a shorter duration than a regular scheduled event. Thus, notifications for spontaneous events may have shorter broadcast time than regular scheduled events.

Accordingly, when an important or a popular event happens, the event notifications for this event may gradually be relayed from the location of the event to surrounding areas in a bleeding out or rippling manner to notify devices in the surrounding area, such as initially from a BLE beacon to a first user device to a second user device and so on. Nevertheless, the event notification is not broadcasted indefinitely, but may spread for a predetermined amount of time to ensure that old events are not broadcast to customers and that the customers receive fresh or new event notifications.

By using the above process 300, event notifications may be received and relevant event notifications may be selected based on user 105's preferences. Thus, relevant event notifications may be presented to user 105. Further, user 105 may provide feedback regarding the event to correct event information or to help identify popular events. Thus, by the above process 300, user 105 may receive event notification for unannounced or spontaneous events from other user's devices via BLE or NFC communication. Further, user device 110 may serve as a notification relay device to relay important or popular event notifications to other nearby devices. As such, important or popular events may be broadcasted in a bleeding out or rippling manner by crowd sourcing.

The above processes 200 and 300 may be executed by user device 110. In some embodiments, the processes 200 and 300 may be executed at merchant device 140. In some other embodiments, above processes 200 and 300 may be executed by one or both of user device 110 and merchant device 140 in coordination with each other.

The following are exemplary scenarios in which the above processes 200 and 300 may be implemented.

### Example 1

Amy enjoys popular music. Amy typically uses a mobile phone to purchase or play popular songs. Amy also attends various music concerts by popular artists. In particular, Amy has a Stubhub app installed in the mobile phone for browsing and purchasing various concert tickets. The Stubhub app creates a music profile for Amy including Amy's various preferences for music, songs, artists, and the like based on Amy's purchase history, browsing history, music/video streaming history, and etc.

Amy attends a popular music festival SXSW every year. The music festival SXSW is attended by various music artists. Many venues are provided in the music festival for various music performances and concerts, which occur throughout the festival. In many instances, several concerts may occur concurrently. Although most events are formally scheduled, spontaneous or unannounced surprise performances also take place during the festival.

As usual, Amy is planning on attending the SXSW festival this year. Although many events are listed on the festival schedule, Amy is particularly excited about seeing surprise or unadvertised concerts. In particular, Amy heard through rumors that her favorite artist may be making a surprise appearance during the festival. During the festival, Amy uses her mobile device to help navigate her through various events. A network of BLE beacons is installed throughout the festival to facilitate notifications and communication among various communication devices of attendees. In particular, the network of BLE beacons receives event notifications from attendees' mobile devices, organizes the event notifications, and broadcasts the event notifications to attendees.

On the second day of the festival, Amy's favorite artist is making a surprise performance. Unfortunately, even though Amy is attending another concert nearby, Amy is not aware of this surprise performance by her favorite artist, because her favorite artist's surprise performance is unannounced. Some attendees who are attending the surprise performance record audio/video of the surprise performance. Some attendees of the surprise performance also send messages or post online messages regarding the surprise performance. Their mobile devices detect that the attendees' inputs are event related and generate event notifications for the surprise performance. The event notifications are broadcast from their mobile devices to nearby mobile devices. Further, the network of BLE beacons also receive the event notifications and begin to broadcast the event notification regarding the surprise performance.

Amy's mobile device receives the event notification for the surprise performance via BLE or NFC communication from the mobile device of another attendee who is passing by and/or from the network of BLE beacons. Amy's mobile device analyzes the event notifications and notes that the surprise performance is performed by Amy's favorite artist based on Amy's music preference profile. Thus, Amy's mobile device immediately presents the event notification to Amy, including a location of the event. The event notification also provides a link for purchasing a ticket for the surprise performance. Amy sees the event notification and quickly purchases a ticket for the surprise performance using the link. Thus, Amy is notified of the surprise performance by her favorite artist in real time and is able to purchase a ticket to attend the surprise performance.

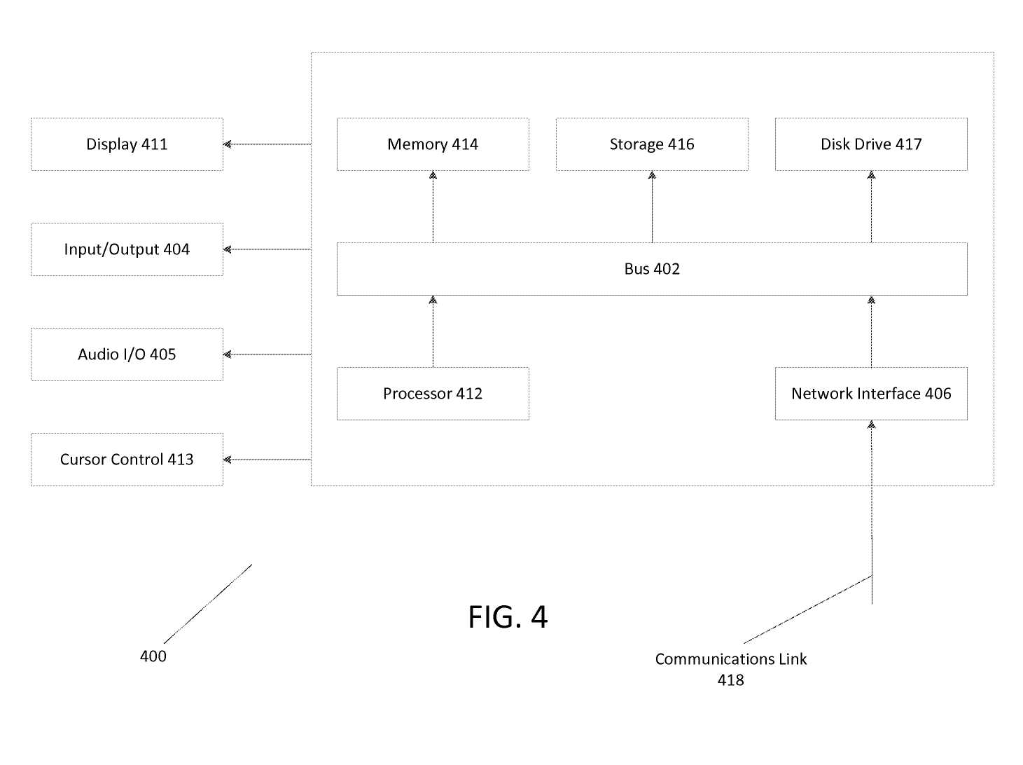

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, Bluetooth device, wearable computing device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 160. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing information about a user account, wherein the information comprises a user's preferences; and
one or more processors in communication with the memory and adapted to:
receive, via near field communication (NFC), an event notification regarding an occurrence of an event from a communication device;
determine whether the event notification is relevant to the user based on the user's preferences; and
present the event notification to the user when the event notification is relevant.

2. The system of claim 1,
wherein the event notification comprises a time stamp indicating when the event notification was generated;
wherein the one or more processors are further adapted to broadcast the event notification to nearby communication devices before a predetermined length of time has elapsed since the time stamp.

3. The system of claim 1,
wherein the event notification comprises a time stamp indicating when the event notification was generated, and
wherein the one or more processors are further adapted to:
determine a probability that the event associated with the event notification still is occurring based on the time stamp of the event notification; and
present the probability to the user along with the event notification.

4. The system of claim 3, wherein the probability that the event is still occurring is greater when the time stamp is more recent.

5. The system of claim 1,
wherein the user's preferences comprise a music preference, and
wherein the one or more processors are further adapted to determine the user's music preference based on one or more of the user's music purchase history, music streaming history, and browsing history.

6. The system of claim 5,
wherein the music preference comprises a list of music artists preferred by the user, and
wherein the event notification is relevant when the event notification is related to one of the list of music artists.

7. The system of claim 1, wherein the event notification comprises directions for attending the event.

8. The system of claim 1, wherein the event notification comprises a link to a merchant for purchasing an admission ticket to the event.

9. The system of claim 1, wherein the event notification is received via Bluetooth Low Energy (BLE) communication.

10. A method comprising:
receiving, by a processor of a communication device, a user input at the communication device;
determining, by the processor, whether the user input is related to an event;
determining, by the processor, characteristics of the event based on a content of the user input;
generating, by the processor, an event notification for the event; and
broadcasting, by the processor, the event notification to nearby devices via near field communication (NFC).

11. The method of claim 10, wherein the characteristics of the event are extracted from the content of the user input using one or more of a keyword identification, an image recognition, and an audio recognition methods.

12. The method of claim 10,
wherein the event notification includes a time stamp indicating when the event notification is generated, and
wherein the event notification is continuously broadcasted until a predetermined length of time has elapsed since the time stamp.

13. The method of claim 10, wherein the user input is one or more of a text message, an online posting, a video recording, and an audio recording,

14. The method of claim 10, wherein the event notification is broadcasted via Bluetooth Low Energy (BLE) communication.

15. The method of claim 10, wherein the event notification includes a time stamp indicating when the event notification is generated.

16. The method of claim 15, wherein the event notification is continuously broadcasted until a predetermined length of time has elapsed since the time stamp.

17. A non-transitory machine-readable medium comprising a plurality of machine-readable instructions which when executed by one or more processors are adapted to cause the one or more processors to perform a method comprising:
receiving, via near field communication (NFC), an event notification regarding an occurrence of an event broadcasted from a communication device;
determining whether the event notification is relevant to the user based on preferences of a user; and
presenting the event notification to the user when the event notification is relevant.

18. The non-transitory machine-readable medium of claim 17,
wherein the event notification comprises a time stamp indicating when the event notification was generated;
wherein the method further comprises broadcasting the event notification to other nearby communication devices before a predetermined length of time has elapsed since the time stamp.

19. The non-transitory machine-readable medium of claim 17,
wherein the event notification comprises a time stamp indicating when the event notification was generated, and
wherein the method further comprises:
determining a probability that the event associated with the event notification still is occurring based on the time stamp of the event notification; and
presenting the probability to the user along with the event notification.

20. The non-transitory machine-readable medium of claim 19, wherein the probability that the event is still occurring is greater when the time stamp is more recent.
